(19) United States
(12) Patent Application Publication
(10) Pub. No.: US 2014/0153471 A1
(43) Pub. Date: Jun. 5, 2014

(54) ALLOWING UNICAST SUBFRAME STRUCTURE FOR EMBMS

(71) Applicant: QUALCOMM Incorporated, San Diego, CA (US)

(72) Inventors: Xiaoxia Zhang, San Diego, CA (US); Jun Wang, San Diego, CA (US); Gordon Kent Walker, San Diego, CA (US); Adrian J. Prentice, San Diego, CA (US)

(73) Assignee: QUALCOMM Incorporated, San Diego, CA (US)

(21) Appl. No.: 13/957,363

(22) Filed: Aug. 1, 2013

Related U.S. Application Data
(60) Provisional application No. 61/732,261, filed on Nov. 30, 2012.

(51) Int. Cl. H04W 4/06

(52) U.S. Cl. CPC H04W 4/06
USPC 370/312

(57) ABSTRACT

A method, an apparatus, and a computer program product for wireless communication are provided. The apparatus receives a multicast/broadcast single frequency network (MBSFN) subframe configured based on a unicast subframe structure, and transmits MBSFN signals for eMBMS using the MBSFN subframe. In a one configuration, the MBSFN subframe structure for eMBMS transmissions uses the same CP length, the same common reference signal (CRS) pattern and same subframe structure used for unicast, along with the same antenna ports used for unicast transmission. In another configuration, the MBSFN subframe structure for eMBMS transmissions uses the same CP length and same subframe structure used for unicast, but potentially different CRS patterns and different antenna ports from those used for unicast transmissions. In another configuration, the MBSFN subframe structure for eMBMS transmission uses the same CP length and same subframe structure used for unicast, but with a UE-RS pattern.

### CROSS-REFERENCE TO RELATED APPLICATION(S)

This application claims the benefit of U.S. Provisional Application Ser. No. 61/732,261, entitled “Allowing Unicast Subframe Structure for eMBMS” and filed on Nov. 30, 2012, which is expressly incorporated by reference herein in its entirety.

### BACKGROUND

1. Field

The present disclosure relates generally to communication systems, and more particularly, to allowing unicast subframe structure for eMBMS.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). LTE is designed to better support mobile broadband Internet access by improving spectral efficiency, lowering costs, improving services, making use of new spectrum, and better integrating with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

A method, an apparatus, and a computer program product for wireless communication are provided. The apparatus receives a multicast/broadcast single frequency network (MBSFN) subframe configured based on a unicast subframe structure, and transmits MBSFN signals for eMBMS using the MBSFN subframe. In a one configuration, the MBSFN subframe structure for eMBMS transmissions uses the same cyclic prefix (CP) length, the same common reference signal (CRS) pattern and same subframe structure used for unicast, along with the same antenna ports used for unicast transmission. In another configuration, the MBSFN subframe structure for eMBMS transmissions uses the same CP length and same subframe structure used for unicast, but potentially different CRS patterns and different antenna ports from those used for unicast transmissions. In another configuration, the MBSFN subframe structure for eMBMS transmission uses the same CP length and same subframe structure used for unicast, but with a UE-RS pattern.

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control planes.

FIG. 6 is a diagram illustrating an example of an evolved Node B and user equipment in an access network.

FIG. 7 is a diagram illustrating evolved Multimedia Broadcast Multicast Service in a Multicast Broadcast Single Frequency Network.

FIG. 8A illustrates a conventional unicast subframe structure with common reference signal (CRS) in normal CP, for a one antenna port configuration.

FIGS. 8B and 8C illustrate a conventional unicast subframe structure with CRS in normal CP, for a two antenna port configuration.

FIGS. 8D-8G illustrate a conventional unicast subframe structure with CRS in normal CP, for a four antenna port configuration.

FIGS. 9A-9D illustrate a conventional unicast subframe structure with UE specific reference signal (UE-RS) in normal CP for special downlink (DL) subframe configurations 1, 2, 6 or 7.

FIGS. 9E-9H illustrate a conventional unicast subframe structure with UE-RS in normal CP for special DL subframe configurations 3, 4, 8 or 9.

FIGS. 9I-9L illustrate a conventional unicast subframe structure with UE-RS in normal CP for all other DL subframe configurations.

FIG. 10 illustrates a conventional or existing MBSFN subframe structure for use in eMBMS having a fixed CP on mixed carrier for an antenna port 4 configuration.

FIG. 11 is a flow chart of a method of wireless communication of a base station.

FIG. 12 is a conceptual data flow diagram illustrating the data flow between different modules/means/components in an exemplary apparatus.

FIG. 13 is a diagram illustrating an example of a hardware implementation for an apparatus employing a processing system.

FIG. 14 is a flow chart of a method of wireless communication of one or more components of a cellular network.

FIG. 15 is a conceptual data flow diagram illustrating the data flow between different modules/means/components in an exemplary apparatus.

FIG. 16 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

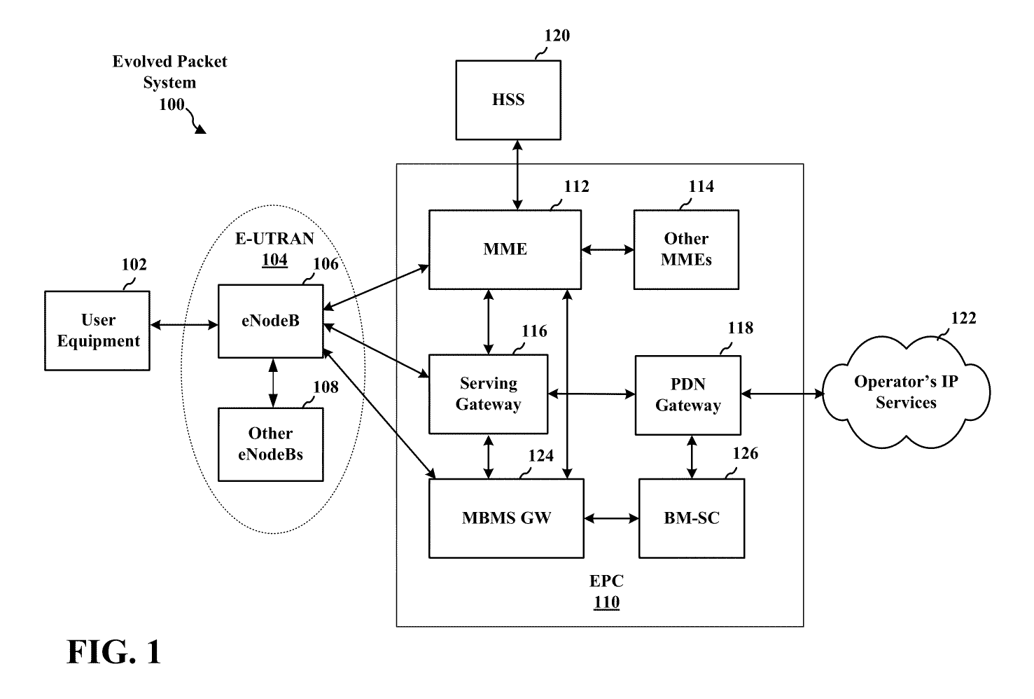

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's Internet Protocol (IP) Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108. The eNB 106 provides user and control planes protocol terminations toward the UE 102. The eNB 106 may be connected to the other eNBs 108 via a backhaul (e.g., an X2 interface). The eNB 106 may also be referred to as a base station, a Node B, an access point, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected to the EPC 110. The EPC 110 includes a Mobility Management Entity (MME) 112, other MMEs 114, a Serving Gateway 116, a Multimedia Broadcast Multicast Service (MBMS) Gateway 124, a Broadcast Multicast Service Center (BM-SC) 126, and a Packet Data Network (PDN) Gateway 118. The MME 112 is the control node that processes the signaling between the UE 102 and the EPC 110. Generally, the MME 112 provides bearer and connection management. All user IP packets may be transferred through the Serving Gateway 116, which is connected to the PDN Gateway 118. The PDN Gateway 118 provides UE IP address allocation as well as other functions. The PDN Gateway 118 is connected to the Operator's IP Services 122. The Operator's IP Services 122 may include the Internet, an intranet, an IP Multimedia Subsystem (IMS), and a PS Streaming Service (PSS). The BM-SC 126 may provide functions for MBMS user service provisioning and delivery. The BM-SC 126 may serve as an entry point for content provider MBMS transmission, may be used to authorize and initiate MBMS Bearer Services within a PLMN and may be used to schedule and deliver MBMS transmissions. The MBMS Gateway 124 may be used to distribute MBMS traffic to eNBs belonging to an MBSFN area broadcasting a particular service, may be responsible for session management (start/stop) and for collecting eMBMS related charging information.

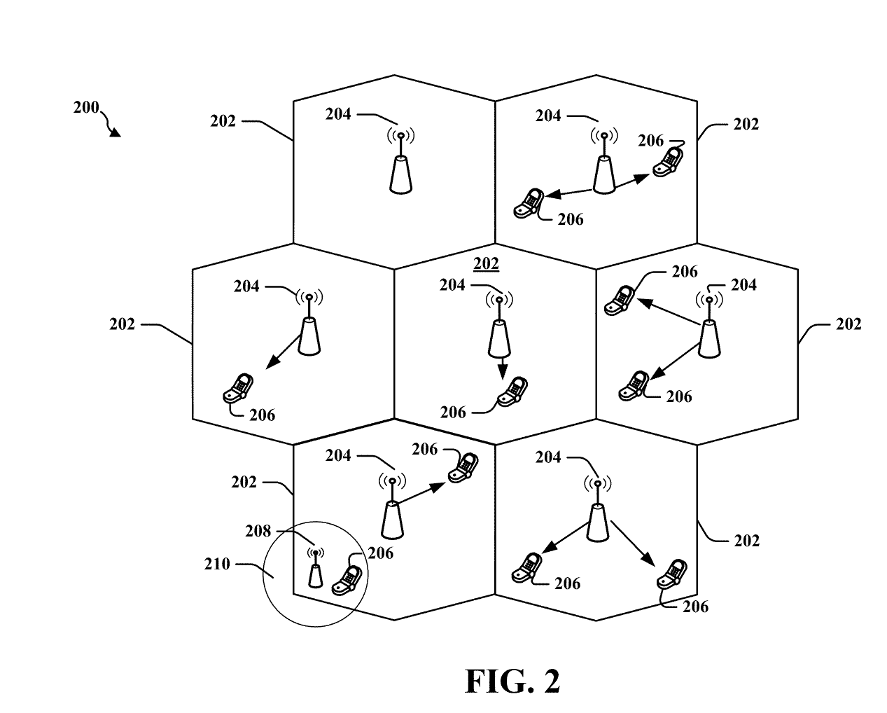

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. The lower power class eNB 208 may be a femto cell (e.g., home eNB (HeNB)), pico cell, micro cell, or remote radio head (RRH). The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116.

The modulation and multiple access scheme employed by the access network 200 may vary depending on the particular telecommunications standard being deployed. In LTE applications, OFDM is used on the DL and SC-FDMA is used on the UL to support both frequency division duplex (FDD) and time division duplex (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data steams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

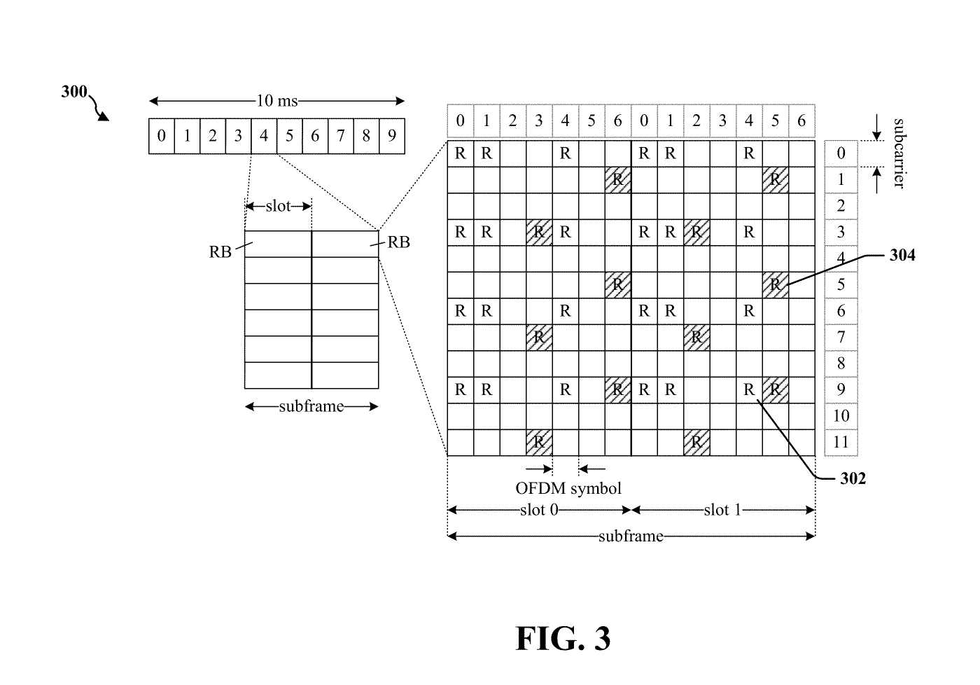

FIG. 3 is a diagram 300 illustrating an example of a DL frame structure in LTE. A frame (10 ms) may be divided into 10 equally sized sub-frames. Each sub-frame may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

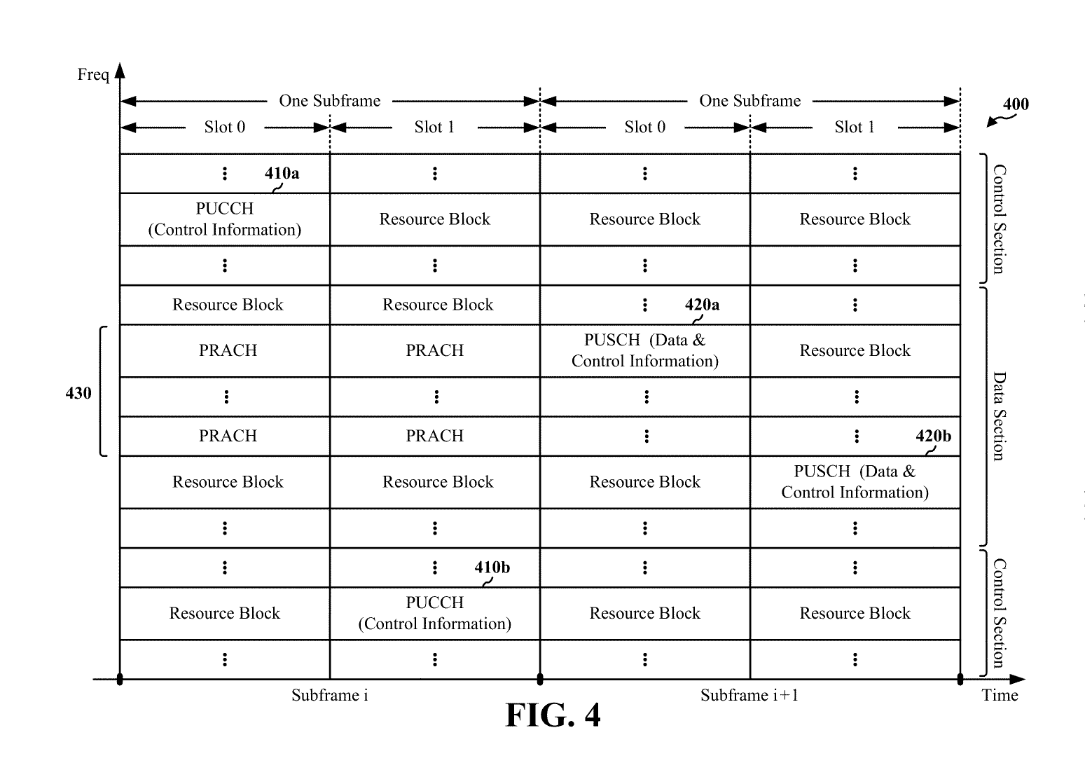

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

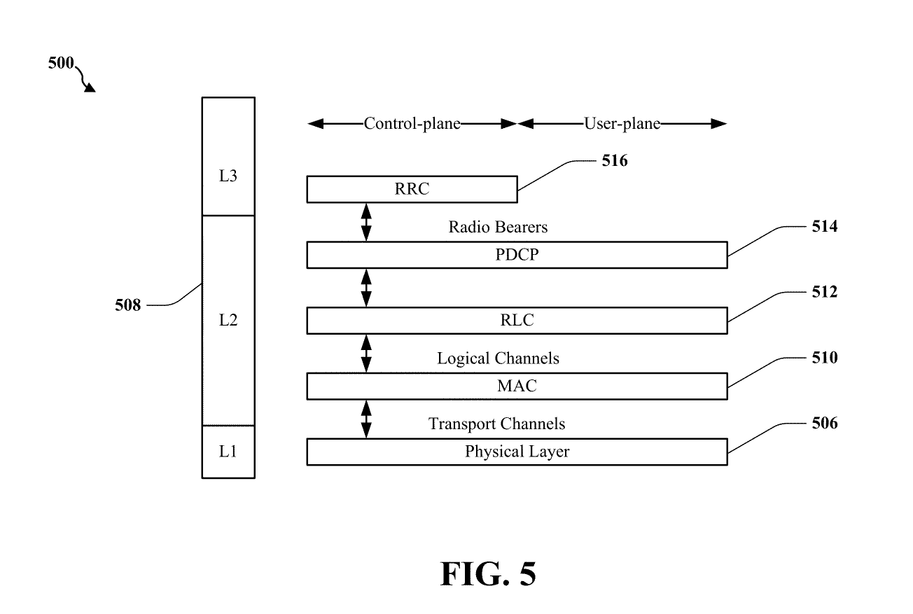

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (i.e., radio bearers) and for configuring the lower layers using RRC signaling between the eNB and the UE.

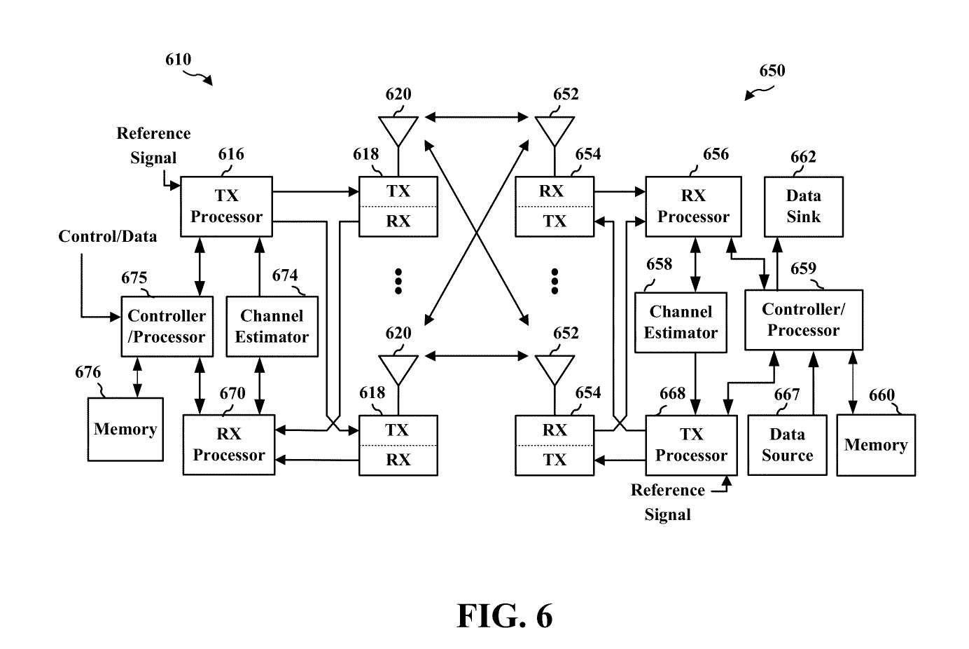

FIG. 6 is a block diagram of an eNB 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions include coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream is then provided to a different antenna 620 via a separate transmitter 618TX. Each transmitter 618TX modulates an RF carrier with a respective spatial stream for transmission, if applicable.

At the UE 650, each receiver 654RX receives a signal through its respective antenna 652. Each receiver 654RX recovers information modulated onto an RF carrier and provides the information to the receive (RX) processor 656. The RX processor 656 implements various signal processing functions of the L1 layer. The RX processor 656 performs spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 are provided to different antenna 652 via separate transmitters 654TX. Each transmitter 654TX modulates an RF carrier with a respective spatial stream for transmission, if applicable.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the control/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

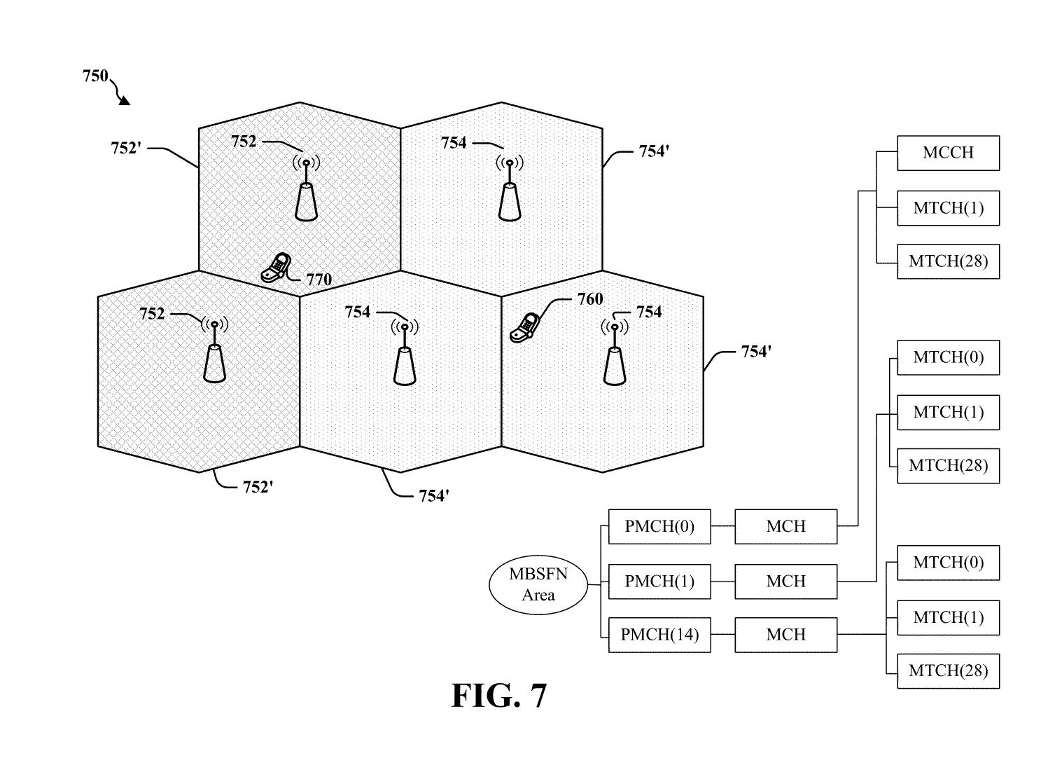

FIG. 7 is a diagram 750 illustrating evolved Multimedia Broadcast Multicast Service (eMBMS) in a Multicast Broadcast Single Frequency Network (MBSFN). The eNBs 752 in cells 752′ may form a first MBSFN area and the eNBs 754 in cells 754′ may form a second MBSFN area. The eNBs 752, 754 may each be associated with other MBSFN areas, for example, up to a total of eight MBSFN areas. A cell within an MBSFN area may be designated a reserved cell. Reserved cells do not provide multicast/broadcast content, but are time-synchronized to the cells 752′, 754′ and have restricted power on MBSFN resources in order to limit interference to the MBSFN areas. Each eNB in an MBSFN area synchronously transmits the same eMBMS control information and data. Each area may support broadcast, multicast, and unicast services. A unicast service is a service intended for a specific user, e.g., a voice call. A multicast service is a service that may be received by a group of users, e.g., a subscription video service. A broadcast service is a service that may be received by all users, e.g., a news broadcast. Referring to FIG. 7, the first MBSFN area may support a first eMBMS broadcast service, such as by providing a particular news broadcast to UE 770. The second MBSFN area may support a second eMBMS broadcast service, such as by providing a different news broadcast to UE 760. Each MBSFN area supports a plurality of physical multicast channels (PMCH) (e.g., 15 PMCHs). Each PMCH corresponds to a multicast channel (MCH). Each MCH can multiplex a plurality (e.g., 29) of multicast logical channels. Each MBSFN area may have one multicast control channel (MCCH). As such, one MCH may multiplex one MCCH and a plurality of multicast traffic channels (MTCHs) and the remaining MCHs may multiplex a plurality of MTCHs.

Current LTE specifications define a subframe structure for transmitting unicast signals that is different from a subframe structure for transmitting MBSFN signals for eMBMS. In general, the MBSFN subframe structure has more overhead compared to the unicast subframe structure.

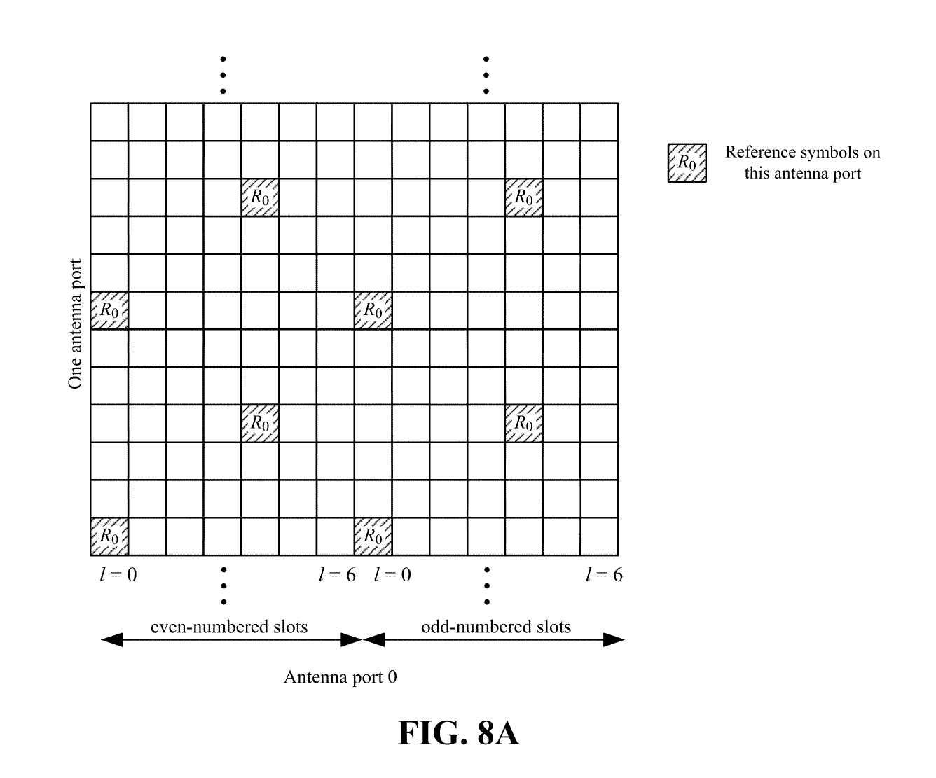

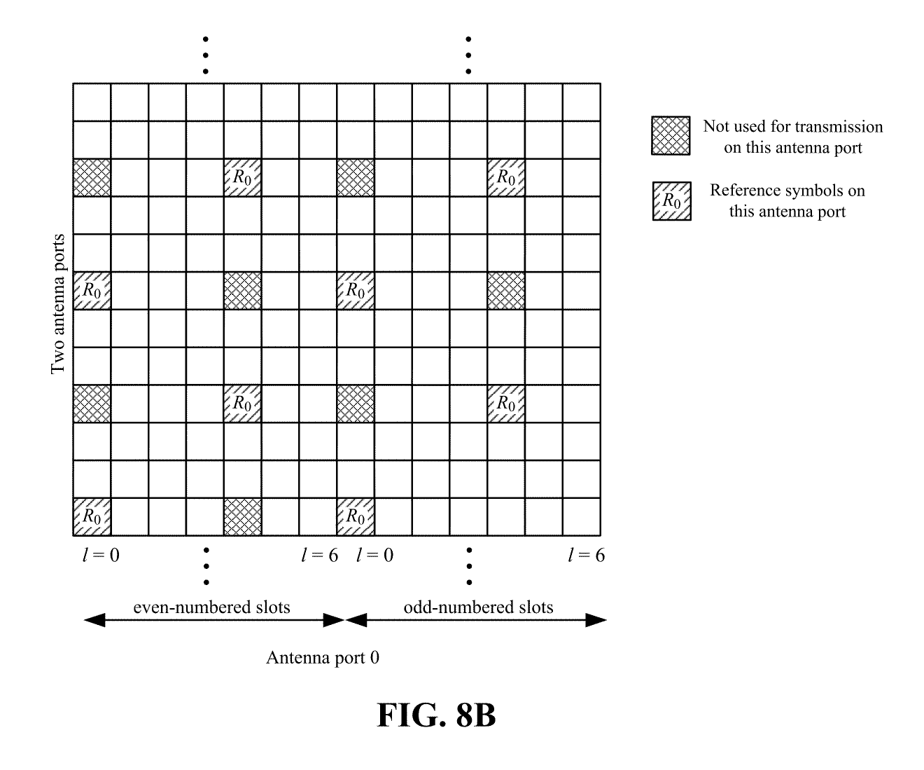

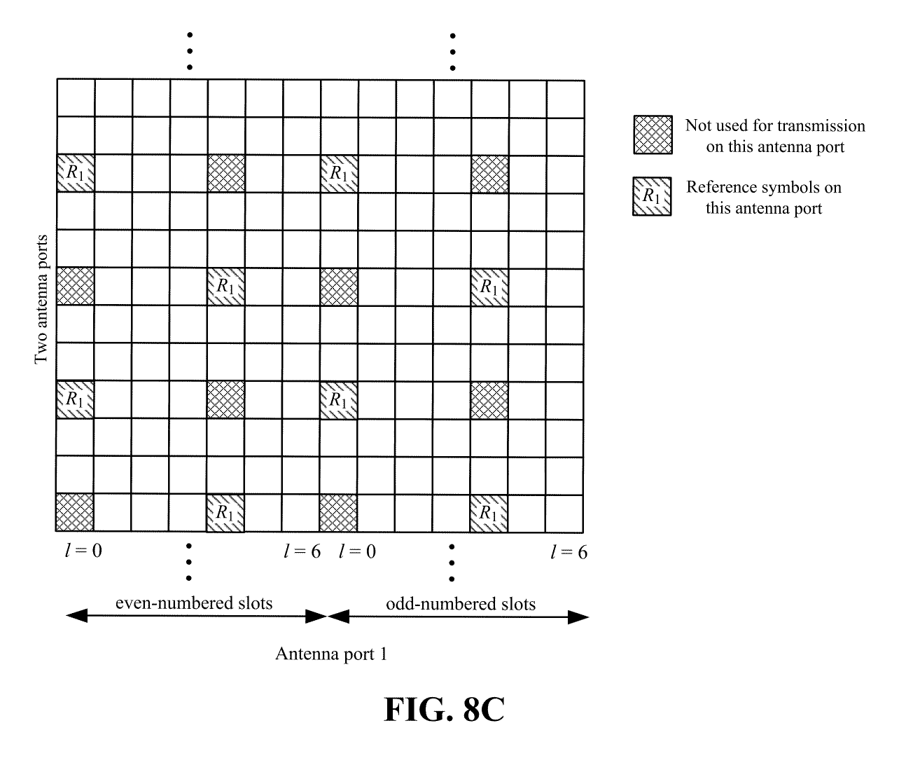

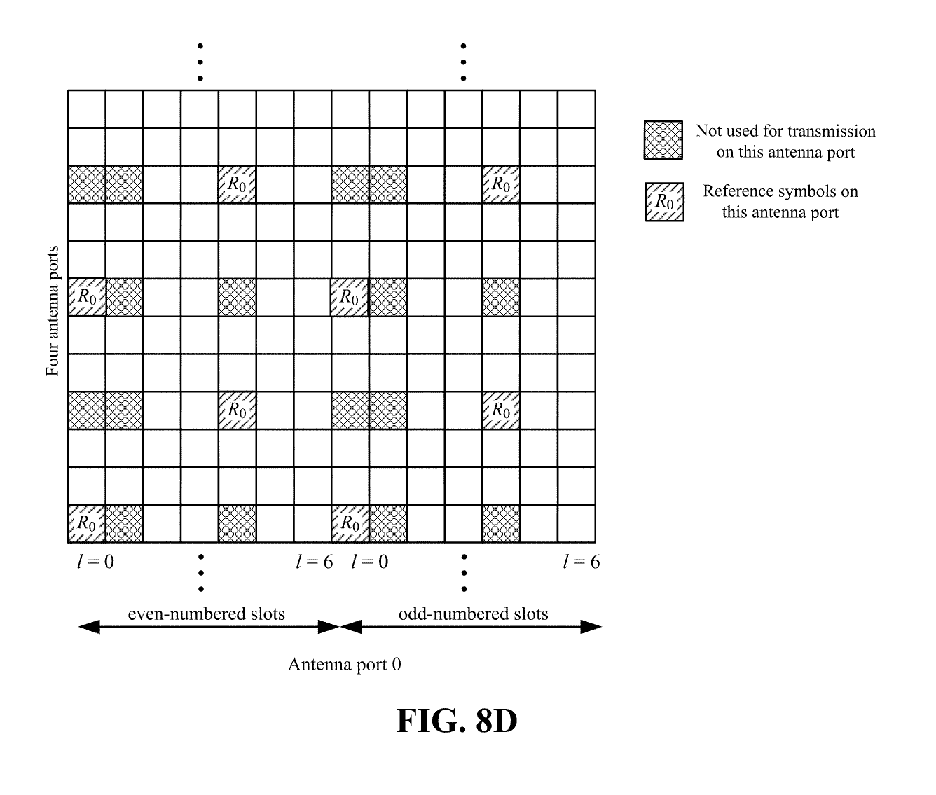

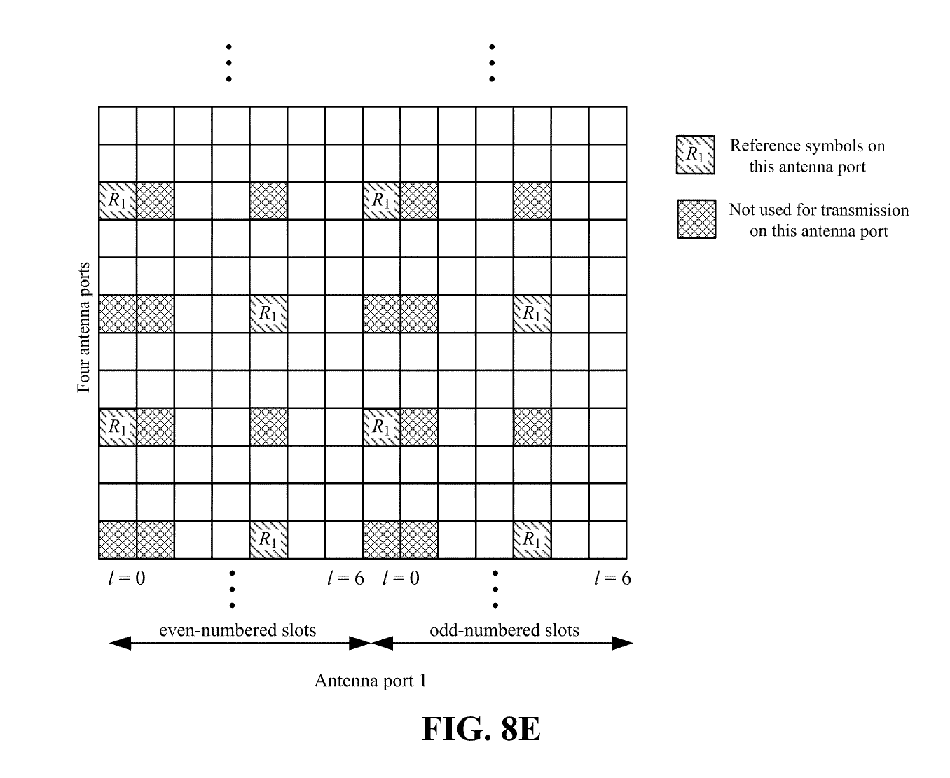

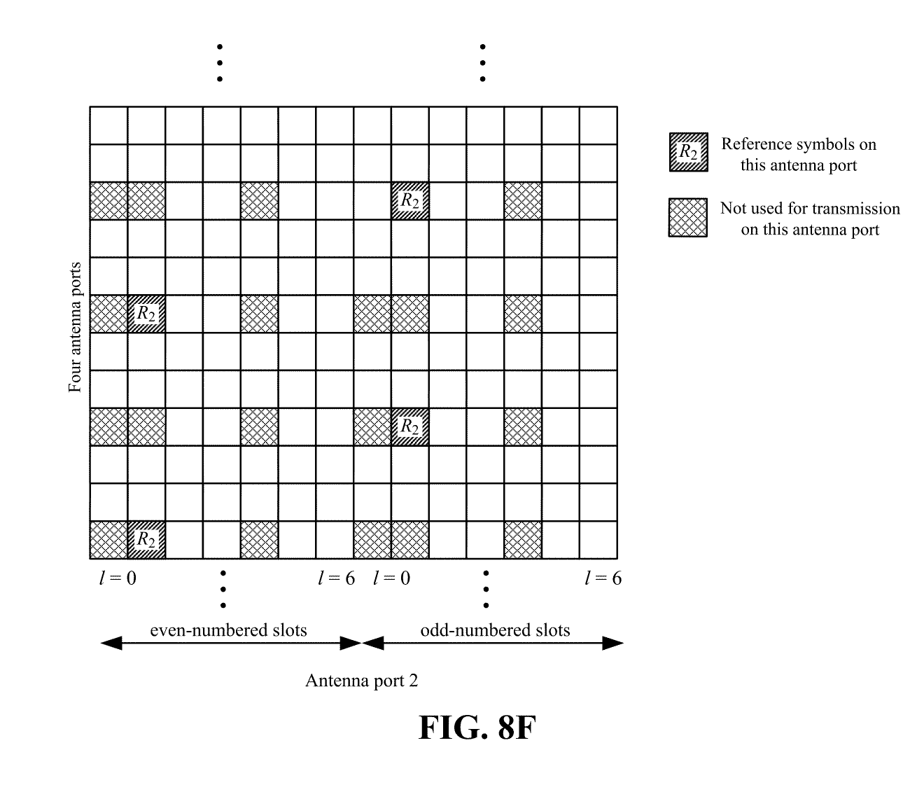

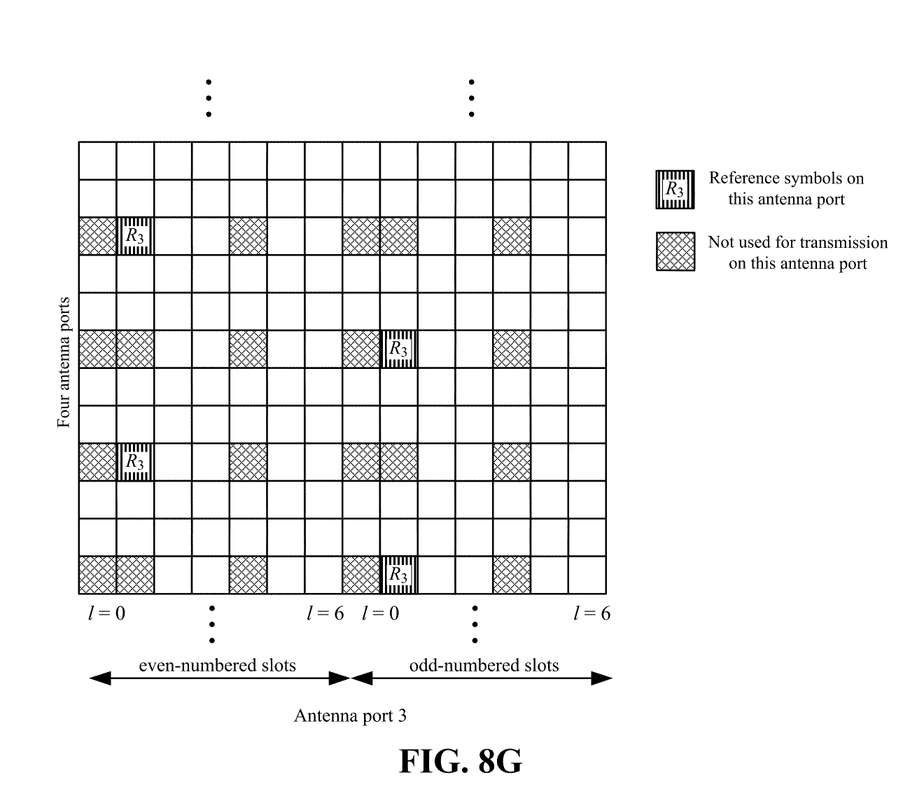

FIGS. 8A-8G illustrate a conventional unicast transmission subframe structure with common reference signal (CRS) with a normal, also referred to as a “short,” cyclic prefix (CP) of about 5 micro seconds (μs), for a one antenna port configuration (FIG. 8A), a two antenna port configuration (FIGS. 8B and 8C), and a four antenna port configuration (FIG. 8D-8G). It is noted that in the four antenna port configuration, port 0 (FIG. 8D) and port 1 (FIG. 8E) have more RSs than port 2 (FIG. 8F) and port 3 (FIG. 8G).

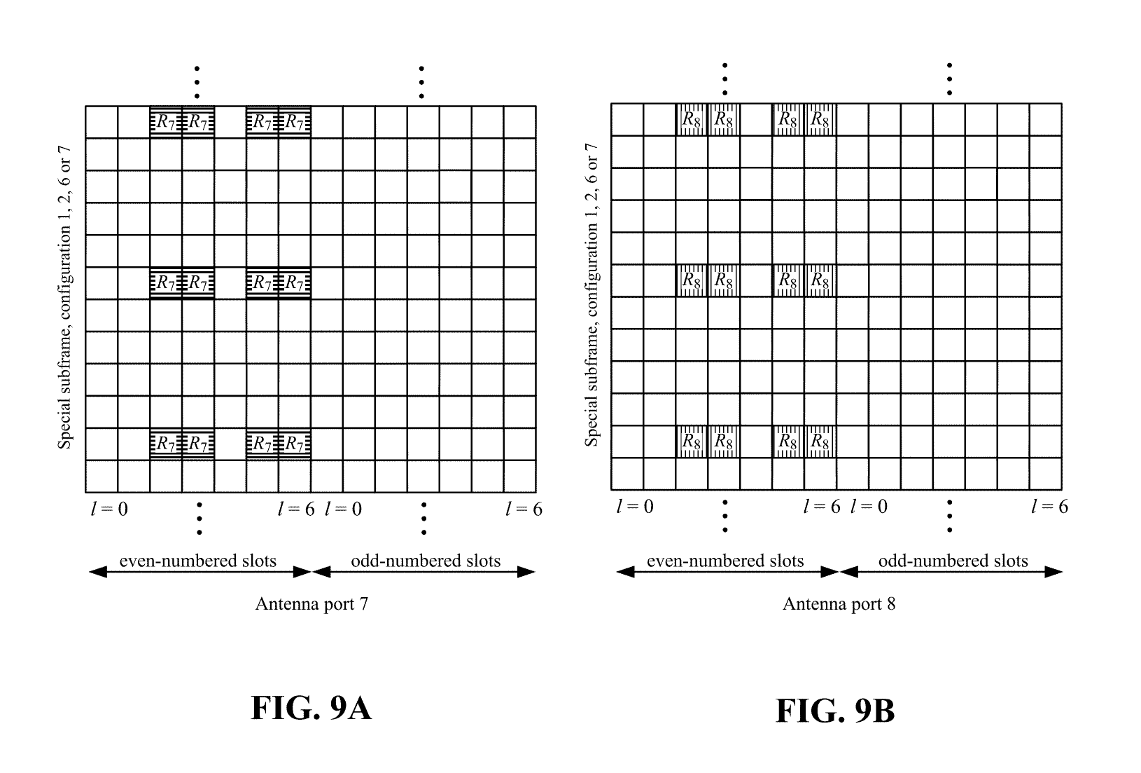

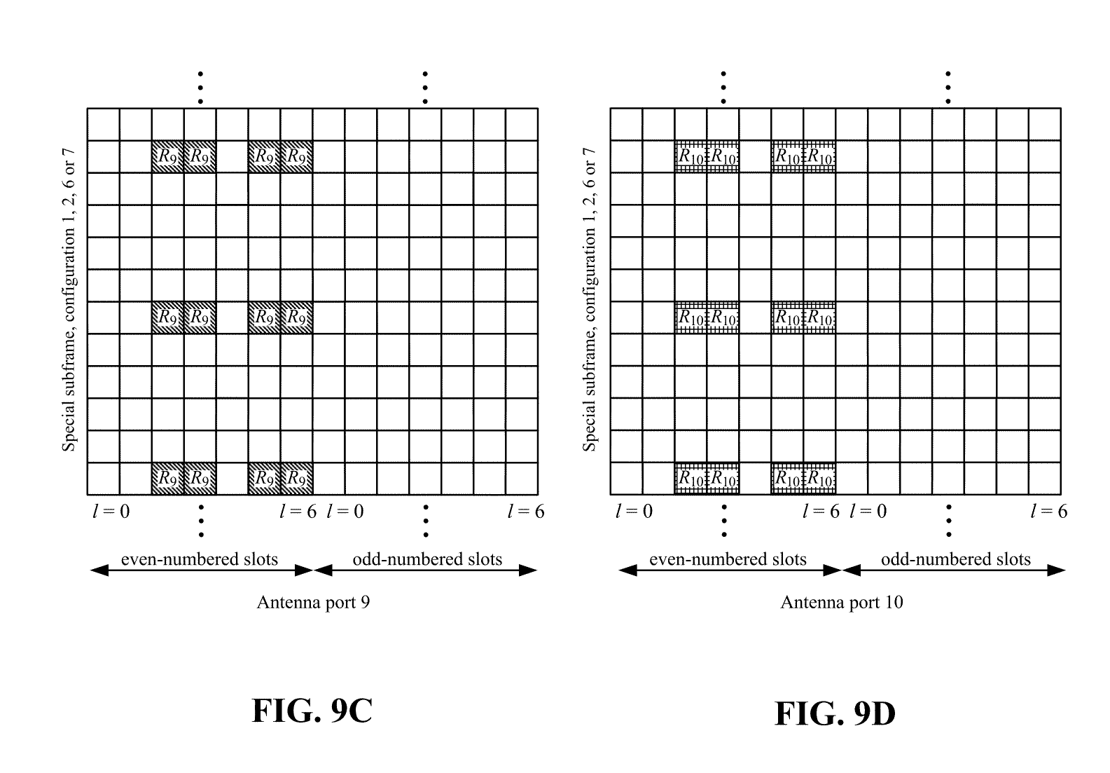

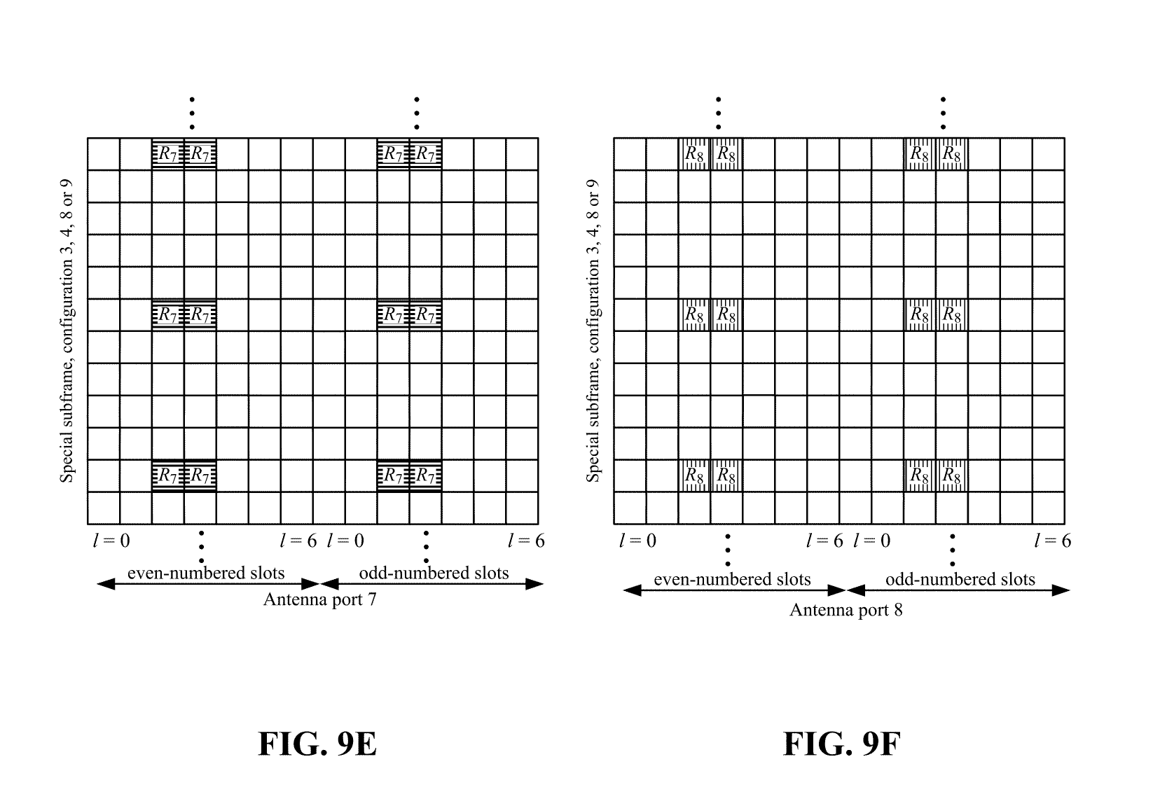

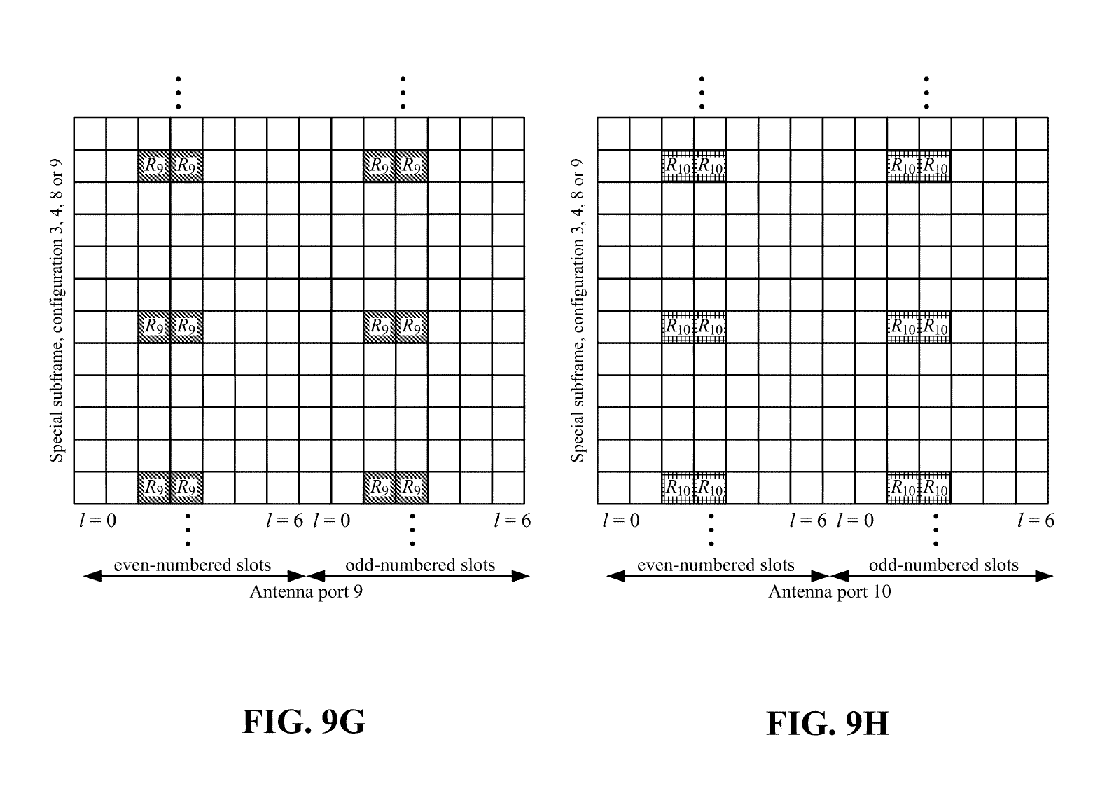

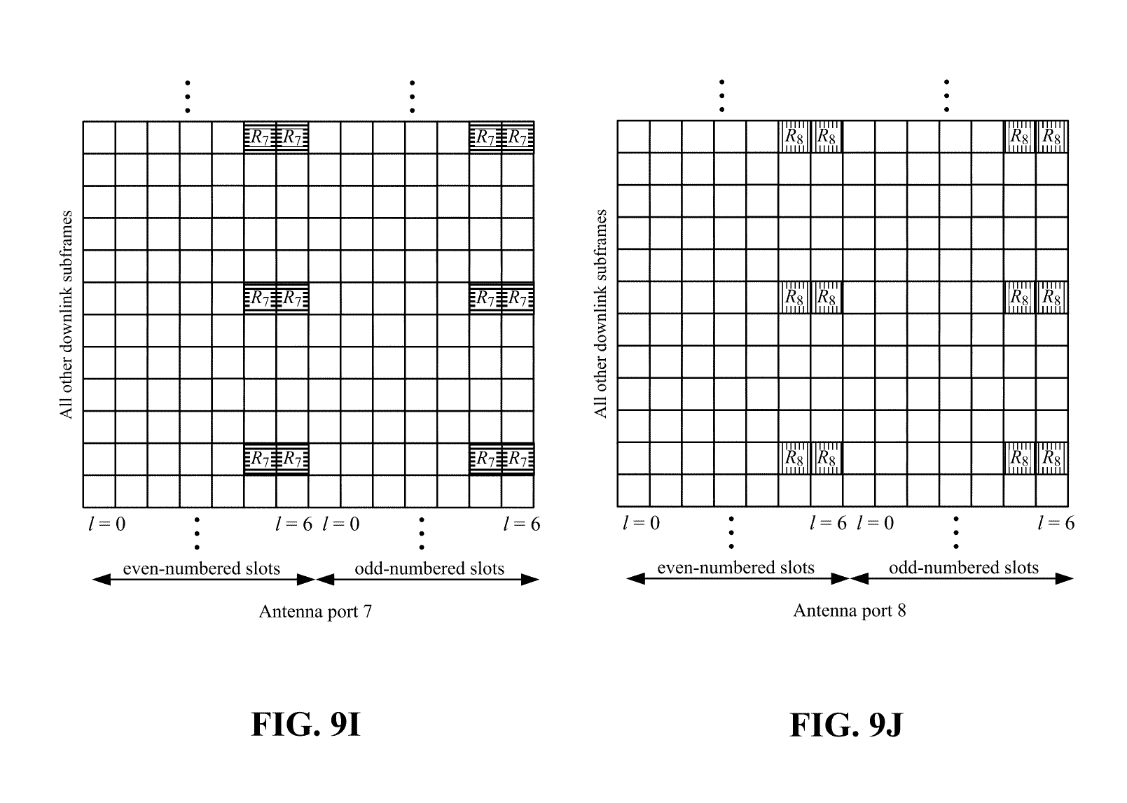

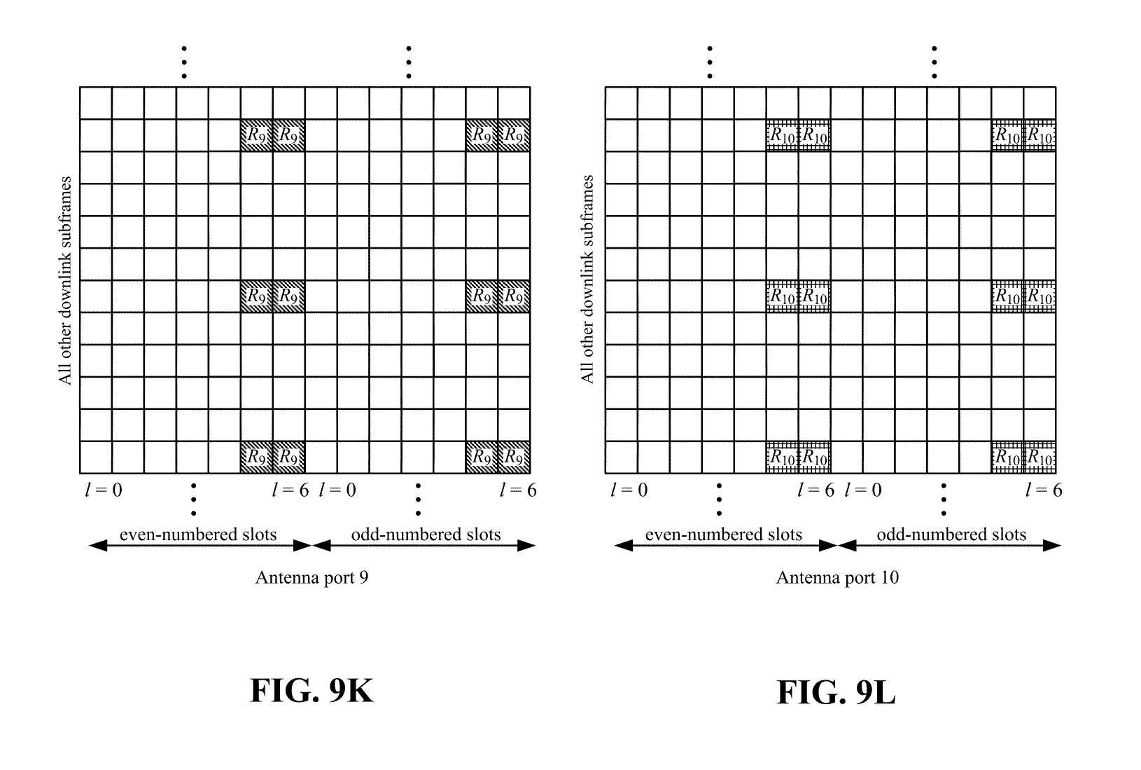

FIGS. 9A-9L illustrate a conventional unicast subframe structure with UE specific reference signal (UE-RS) with a normal CP for special downlink (DL) subframe configurations 1, 2, 6 or 7 (FIGS. 9A-9D), for special DL subframe configurations 3, 4, 8 or 9 (FIGS. 9E-9H), and for all other all other DL subframe configurations (FIGS. 9I-9L). A new MBSFN subframe configuration, disclosed below, may be configured based on a unicast subframe structure. For example, the new MBSFN configuration may be based on the unicast subframes shown in FIGS. 9A-9H.

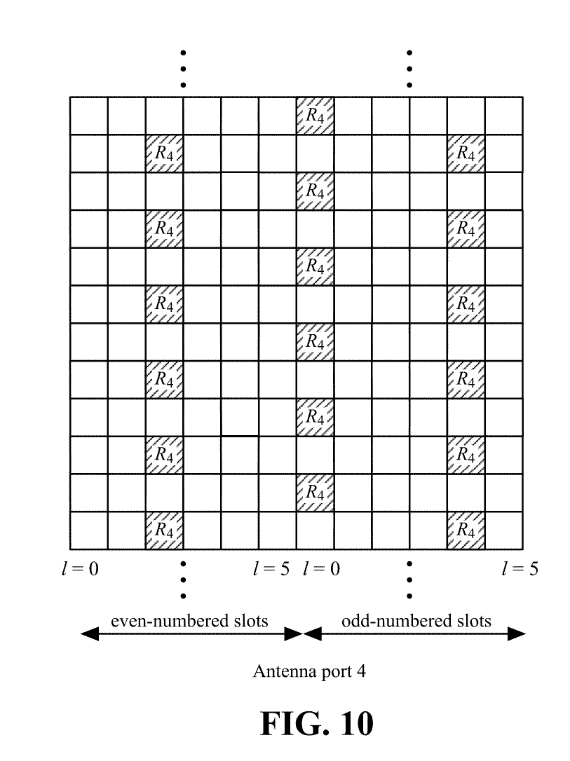

FIG. 10 illustrates a conventional or existing MBSFN subframe structure for use in eMBMS having a fixed CP of about 16.67 μs on mixed carrier for an antenna port 4 configuration. “Mixed carrier” refers to a carrier wherein eMBMS and unicast transmissions are mixed by TDM in one common carrier.

Given the respective CPs, the CP overhead for a unicast subframe structure having a normal CP is approximately 7%, while the CP overhead for a MBSFN subframe structure for eMBMS is approximately 20%. With respect to reference signals (RS) or pilot signals (identified by “R” blocks), the RS pattern for a MBSFN subframe (e.g., FIG. 10) generally is more dense than the RS pattern for a unicast subframe (e.g. FIGS. 8A-8G, FIGS. 9A-9L).

For example, with reference to FIG. 8A, the RS pattern for a single antenna port for unicast with CRS is four pilots per resource block (RB) or eight pilots per subframe for antenna port 0. For this subframe, the RS overhead is four of eighty-four, or about 4.8%. With reference to FIGS. 8B and 8C, the RS pattern for two antenna ports for unicast with CRS is eight pilots per RB or sixteen pilots per subframe for antenna ports 0 and 1. For this subframe, the RS overhead is eight of eighty-four, or about 9.5%. With reference to FIGS. 8D-8G, for up to two layer transmission for unicast with UE-RS, the RS pattern is twelve pilots per RB or 24 pilots per subframe for antenna ports 0, 1, 2 and 3. For this subframe, the RS overhead is twelve of eighty-four, or about 14.2%.

With reference to FIG. 10, the RS pattern for a conventional MBSFN subframe is eighteen pilots per subframe. For this subframe, the RS overhead is eighteen of one-hundred forty-four, or about 12.5%. Based on the above respective RS overheads, it is noted that the RS overheads for a unicast subframe for single antenna port and a unicast subframe for two antenna ports, which may be 4.8% and 9.5% respectively, are less than the RS overhead for a MBSFN subframe, which may be 12.5%.

The current design philosophy for eMBMS transmissions require an extended CP and denser RS patterns due to multiple cells and longer propagation delays involved in MBSFN transmissions. When multiple cells are transmitting MBSFN signals, in order for a UE to benefit from MBSFN gain, typically the CP length has to be long enough for the UE to capture useful signals from cells far away. However, in some use cases, a subframe structure having a normal CP and/or a unicast RS pattern may be sufficient for eMBMS service. Such use cases generally involve a small MBSFN area where expected propagation delays would not exceed the normal CP length. Such a small MBSFN area may include for example, venue scenarios where the venue size is on the order of a small cell size. An example of such a venue is a sports stadium having a number of cells that broadcast stadium related content to UEs present in the stadium. Use of existing MBSFN subframe structures in a small venue to transmit eMBMS content may entail unnecessary system overhead.

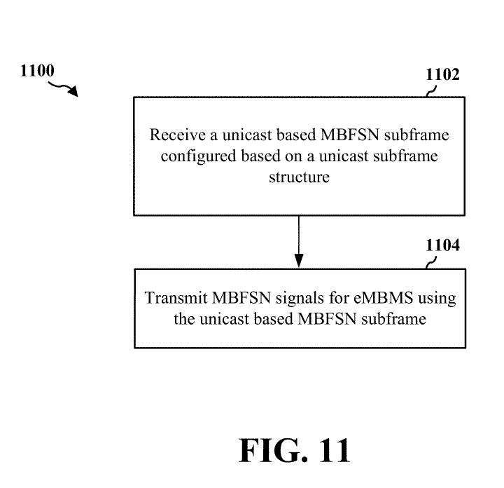

FIG. 11 is a flow chart 1100 of wireless communication. The method may be performed by an eNB. At step 1102, the eNB receives a MBSFN subframe that is configured based on a unicast subframe structure. This MBSFN subframe configuration may be provided to the eNB by a network. Receiving in this sense may encompass receiving information that defines the new MBSFN configuration. At step 1104, the eNB transmits MBSFN signals for eMBMS using the MBSFN subframe configuration. In a first configuration, the MBSFN subframe structure for eMBMS transmissions uses the same CP length, the same common reference signal (CRS) pattern and same subframe structure as used for unicast. Additionally, the same antenna ports are used for eMBMS transmissions as are used for unicast transmission. In a second configuration, the MBSFN subframe structure for eMBMS transmissions uses the same CP length and same subframe structure as used for unicast, but potentially uses different CRS patterns and different antenna ports from those used for unicast transmissions. In a third configuration, the MBSFN subframe structure for eMBMS transmissions uses the same CP length and same subframe structure as used for unicast, but uses a UE-RS pattern.

Implementation of the first configuration involves the addition of a “new” MBSFN subframe configuration in a SIB (e.g., SIB2 or SIB13, or some other SIB). This MBSFN subframe configuration is “new” in that it identifies a conventional unicast subframe configuration having a corresponding CP length, CRS or UE-RS pattern and antennas port arrangement, such as one of those shown in FIGS. 8A-8G and 9A-9L. The new MBSFN subframe configuration, also referred to as a “unicast based MBSFN subframe configuration,” is used to transmit MBSFN signals for eMBMS. SIB2 may still identify an existing MBSFN subframe allocation, however, if an existing MBSFN subframe allocation is present in SIB2, such existing MBSFN subframe allocation may be ignored in favor of the new MBSFN subframe allocation for eMBMS. The existing MBSFN subframes may, however, be used for unicast transmissions based on UE reference signals. In other words, for purposes of eMBMS, any existing MBSFN subframe allocation present in SIB2 may be ignored in favor of the unicast based MBSFN subframe configuration. Because the subframe structure is the same for MBMS and unicast, UEs do not have to bypass new MBSFN symbols when performing channel estimation. eMBMS capable UEs may ignore existing MBSFN subframe allocations and instead use the unicast based MBSFN subframe allocations. The existing SIB13/MCCH/PDCCH notifications/MSI information may be applied on the unicast based MBSFN subframes.

Other information may be involved in the use of the unicast based MBSFN subframe. For example, the SIB13, multicast control channel (MCCH), physical downlink control channel (PDCCH) notification, and MCCH scheduling information (MSI) intended for use with respect to an existing MBSFN subframe may be applied to unicast based MBSFN subframes. In this regard, the existing SIB13/MCCH/PDCCH notification/MSI points to a unicast based MBSFN subframe instead of the existing MBSFN subframe. SIB13 indicates what subframes are used for eMBMS, related parameters for each MBSFN area to acquire MCCH, etc. MCCH indicates, via a physical multicast channel (PMCH)-InfoList, how many MBSFN subframes are used for each PMCH, the MCS for each PMCH, etc. The PDCCH notification indicates whether the MCCH is going to change. The MCCH scheduling information (MSI) indicates, for each multicast traffic channel (MTCH) within a PMCH, which MFSFN subframes are used for a particular service.

In the case where the same antenna ports used for unicast and eMBMS correspond to multiple antennas, the UE obtains a channel estimation using each antenna. More specifically, where unicast is using multiple antennas, the same set of multiple antennas may also be used for eMBMS, with each antenna transmitting the same MBSFN signal. At the receiver side, the UE estimates the channel from each transmit antenna and the respective channel estimations from each antenna are combined to obtain an effective eMBMS channel estimation for eMBMS data demodulation.

In an additional aspect of this configuration, the number of antennas used for eMBMS transmissions and unicast transmissions may be aligned in order to minimize RS overhead for eMBMS. For example, if a carrier to be broadcast by an eNB is mainly targeted for MBSFN transmission (˜100% with PSS/SSS/PBCH/SIB/Paging) in a small MBSFN area, then the eNB may use a single transmitting antenna for unicast and eMBMS. “Mainly” in this context means primarily used for eMBMS transmission but may be used occasionally for unicast transmission. As another example, if all UEs in a system are Category 4 or below (e.g., the UE has 2 layers at most for DL spatial multiplexing in), then two virtual transmit antennas are used for both unicast and eMBMS transmissions even if the eNB has four physical transmit antennas. The two virtual antennas may be obtained using the four physical antennas using well known virtualization techniques.

Multi-antenna techniques for eMBMS may effectively utilize unicast CRS or UE-RS pattern. For example, multiple input multiple output (MIMO) transmission and/or space frequency block code (SFBC) may be used, where common control signals, such as MCCH and MSI, may be transmitted via the SFBC, and data transmitted using MIMO. In this case, the MCCH specifies rank information for each PMCH in addition to MCS for both layers, instead of a single layer. The UE can perform channel estimation from multiple Tx antenna ports using the CRS or UE-RS pattern for eMBMS demodulation.

As noted above, the unicast based MBSFN subframe uses the same CRS pattern as that used in a unicast subframe. This is advantageous in that the UE may perform channel estimations over a series of subframes regardless of whether individual subframes are allocated as a unicast subframe or a unicast based MBSFN subframe. In addition, the same channel estimates can be used for both unicast and eMBMS. Furthermore, because the unicast and MBSFN subframes share the same CRS pattern, a more accurate channel estimation for eMBMS and/or unicast traffic may be obtained.

The foregoing advantages generally are not present with conventional operations where separate unicast and eMBMS channel estimations are performed using separate processors, over a series of unicast subframes and MBSFN subframes, respectively, having different CRS patterns. For example, assuming a first subframe structure corresponds to a one antenna port unicast structure as shown in FIG. 8A, a second subframe structure corresponds to a conventional MBSFN subframe structure as shown in FIG. 10, and a third subframe corresponds to a one antenna port unicast structure as shown in FIG. 8A, the UE may perform channel estimations based on the same RS patterns of the first and third unicast subframe structures. However, at the second subframe structure (the conventional MBSFN subframe structure) the CRS is not present in the MBSFN symbols so the UE should bypass those MBSFN symbols in that subframe for purposes of performing channel estimations.

Another advantage of using the same subframe structure for both unicast and MBSFN transmissions is that the same subframe structure allows MBSFN and unicast elements, e.g., primary synchronization signal (PSS), secondary synchronization signal (SSS), physical broadcast channel (PBCH), SIB and Paging, to coexist in the same subframe. In other words, in addition to time division multiplexing (TDM) between unicast and eMBMS, frequency division multiplexing (FDM) between unicast and eMBMS may also be utilized. In frequency division duplex (FDD) 40% of subframes within a radio frame may be reserved for unicast usage, (e.g., for paging) with a TDM partition between unicast and eMBMS. Under the above configuration, however, because the same subframe structure is used for both unicast and MBSFN more than 60% of the unicast based MBSFN subframe may be allocated for MBSFN usage due to the allowed FDM partition in addition to the TDM partition. When eMBMS and common unicast signaling (e.g., PSS/SSS/PBCH/SIB/Paging targeted for all UEs in a cell) coexist in the same subframe, the eMBMS data transmission can rate match around those resource elements (REs) used for unicast signaling. REs used for PSS/SSS/PBCH are predetermined and are excluded for eMBMS transmission. In a SIB/Paging subframe, the UE may decode the corresponding PDCCH to obtain the REs used for SIB/Paging. The REs used for SIB/Paging are also excluded from eMBMS. The remaining REs (excluding CRS and control) may be used for eMBMS. FDM may not be used between eMBMS and unicast data targeted for individual UE because the PDCCH for individual unicast transmission is scrambled by the UE C-RNTI. A slight change in bit width may need to be made in MCCH/MSI to allow for more than 60% subframe allocation for eMBMS. If unicast based MBSFN subframes are over reserved, e.g., not all the unicast based MBSFN subframes are used from MBSFN transmission, the left over unicast based MBSFN subframes may be used by unicast UEs because the unicast based MBSFN subframes have the same RS pattern as unicast subframes. The unicast based MBSFN subframe configuration may also be applied to a standalone eMBMS carrier in a small MBSFN area.

An additional advantage of this configuration may include no additional UE hardware complexity for eMBMS reception as the UEs can receive unicast transmissions. As such, legacy UEs without existing eMBMS hardware capability can support eMBMS reception using the existing unicast hardware. For such UEs, the features of this configuration may be enabled via a software update/upgrade.

The first configuration described above provides for a subframe configuration that is the same for unicast and eMBMS. This may have the advantage that the UE does not have to do anything different when handling eMBMS subframes. A potential disadvantage is that there can be more overhead for eMBMS than is needed. For example, eMBMS currently uses one antenna while UEs currently use two antennas for unicast, or possibly four antennas. As such, using the unicast subframe configuration for eMBMS would result in additional overhead. For example, using two antennas results in approximately 9.5% overhead as opposed to 4.8% if one antenna were used; and using four antennas results in approximately 14.5% overhead as opposed to 4.8% for one antenna. In the case of a single antenna for unicast and eMBMS, no additional overhead is involved. A second configuration, described further below, may reduce antenna related overhead at the expense of more complexity. Another disadvantage of the first configuration is that the same physical cell identification (PCI) is used for all cells in the MBSFN area in order to align the CRS sequence in both unicast and MBSFN. Also the MBSFN area ID in SIB13 may need to be the same as the PCI. Furthermore, all unicast channels have to be coordinated so that all cells in the MBSFN area transmit the same content at the same time including unicast data. From a UE point of view, the multiple cells in the MBSFN area appear as a single cell because each cell transmits identical waveforms in a synchronized manner. As a result, there is no cell splitting gain for unicast, as is the case when different cells transmit to different UEs at the same time. The second configuration may alleviate these potential disadvantages.

In a second configuration, the unicast based MBSFN subframe structure for eMBMS transmissions may use the same CP length as a unicast subframe structure, but may use different CRS patterns and/or different antenna ports from those used for unicast transmissions. Because the CRS patterns can be different for unicast and eMBMS in the second configuration, SIB2 includes existing and new MBSFBN subframes so that when different CRS patterns are involved, the UE can bypass all MBSFN subframes (both existing and new) declared in SIB2 for CRS based channel estimation. Furthermore, the unicast and eMBMS transmissions may use different antenna ports, allowing a different scrambling sequence to be used. For example, the unicast CRS may be scrambled by the PCI while the eMBMS RS may be scrambled by the MBSFN area ID.

In the second configuration, MBSFNSubframeConfigList in SIB2 declares an allocation of MBSFN subframes including both an existing MBSFN subframe allocation and a unicast based MBSFN subframe allocation. If an existing MBSFN subframe allocation is present in SIB2, it is not used for eMBMS. The existing MBSFN subframe may, however, be used for unicast transmissions based on the UE reference signal. In other words, for purposes of eMBMS, any existing MBSFN subframe allocation present in SIB2 is ignored in favor of the new subframe allocation in SIB2. When different CRS patterns are involved, the UE bypasses both the existing and unicast based MBSFN subframes declared in SIB2 for CRS based channel estimations. An example configuration can be that in SIB2, the current MBSFN-SubframeConfigList lists both existing and unicast based MBSFN subframes. Out of these MBSFN subframes declared in SIB2, a flag can be added to new, unicast based subframes so the UE can distinguish between existing and unicast based MBSFN subframes. If any of the new, unicast based MBSFN subframes are not used for eMBMS, the left over, unused unicast based MBSFN subframes may be used for unicast.

As with the first configuration, other information may be involved in the use of the unicast based MBSFN subframe with the second configuration. For example, the SIB13, multicast control channel (MCCH), physical downlink control channel (PDCCH) notification, and MCCH scheduling information (MSI) intended for use with respect to an existing MBSFN subframe may be applied to unicast based MBSFN subframes. In this regard, the existing SIB13/MCCH/PDCCH notification/MSI points to a unicast based MBSFN subframe instead of the existing MSFN subframe. The UE is now configured to use the unicast based MBSFN subframes for eMBMS reception with SIB13/MCCH/PDCCH notification/MSI pointing to the new unicast based MBSFN subframes.

A potential advantage of the second configuration is that PCIs may be different for different cells within the same MBSFN area. Furthermore, RS overhead for eMBMS can be kept to a minimum.

Regarding CRS patterns and antenna ports, in some cases, unicast transmission and eMBMS transmission may involve a different number of antennas and different corresponding CRS patterns. For example, a unicast transmission may transmit on two antennas and use a CRS pattern corresponding to the subframe structures of FIGS. 8B and 8C, while an eMBMS transmission may transmit on a single antenna and thus use a unicast based MBSFN subframe structure and CRS pattern corresponding to the subframe structure of FIG. 8A. These respective subframe structures involve different CRS patterns; as such the unicast CRS patterns or antenna ports are not necessarily present in the unicast based MBSFN subframes. In such cases, the UE bypasses all MBSFN symbols in all MBSFN subframes declared in SIB2 when performing CRS based channel estimation and maintains different channel estimates for unicast and eMBMS. The inclusion of both an existing MBSFN subframe allocation, if any, and a unicast based MBSFN subframe allocation in SIB2, minimizes any impact on legacy unicast-only-capable UEs.

Under the second configuration, if unicast based MBSFN subframes are over reserved, the unused unicast based MBSFN subframes may be used by those unicast UEs corresponding to LTE Rel-10+ UEs configured in transmission mode 9. Rel-10+ means Rel-10 and beyond, e.g., Rel-10/11/12. Similarly with the third configuration, if there is left-over new, unicast based MBSFN subframes for eMBMS traffic, these left over subframes may be used for unicast. This is different from the first configuration, where unused unicast based MBSFN subframe may be used by any UE regardless of the supported LTE release number, because the unicast based MBSFN subframes have the same CRS pattern as unicast. Under the second configuration, however, even though the same subframe structure is used for both unicast and MBSFN, different antenna ports are used for unicast and eMBMS, hence only up to 60% may be allocated as unicast based MBSFN subframes, while under the first configuration, more than 60% of the unicast based MBSFN subframes may be allocated for MBSFN usage due to allowed FDM partition in addition to TDM partition.

In a third configuration, the unicast based MBSFN subframe structure for eMBMS transmission uses the same CP length and same subframe structure used for unicast, but uses a UE-RS pattern, as opposed to a CRS pattern. In LTE Rel-11, UE-RS patterns may be scrambled based on a signaled virtual cell ID instead of the PCI. In the third configuration, eMBMS transmissions may use MBSFN subframe structures that are based on a unicast subframe structure having an RS pattern corresponding to a UE-RS pattern that is scrambled by MBSFN area ID instead of the PCI. This may be done by setting the virtual cell ID provided in LTE Rel-11 to the MBSFN area ID. This allows all cells to transmit using the same UE-RS pattern. Given that a single layer is used for eMBMS, antenna port 7 (or port 8) in FIG. 9A, 9E or 9I (or FIG. 9B, 9F or 9J) may be used to transmit MBSFN signals.

Similar to the second configuration described above, the MBSFN SubframeConfigList in SIB2 declares an allocation of MBSFN subframes including both an existing MBSFN subframe allocation and a unicast based MBSFN subframe allocation. If an existing MBSFN subframe allocation is present in SIB2, the existing MBSFN allocation is not used for eMBMS. The existing MBSFN subframe may, however, be used for unicast transmissions based on the UE-RS. Furthermore, as with the first and second configurations, other information may be involved in the use of the unicast based MBSFN subframe with the third configuration. For example, the SIB13, MCCH, PDCCH notification, and MSI intended for use with respect to an existing MBSFN subframe may be applied to unicast based MBSFN subframes. In this regard, the existing SIB13/MCCH/PDCCH notification/MSI point to a unicast based MBSFN subframe instead of the existing MBSFN subframe.

Potential advantages of the third configuration include no additional UE hardware complexity assuming the UE already has full LTE Rel-11 unicast support. Even UEs without existing eMBMS hardware capability can support eMBMS. Also, the multi-antenna techniques for eMBMS may effectively utilize a unicast UE-RS pattern. For example, multiple input multiple output (MIMO) transmission and/or a space frequency block code (SFBC) may be used, where common control signals, such as MCCH and MSI, may be transmitted via the SFBC, and data transmitted using MIMO. In this case, the MCCH specifies rank information for each PMCH in addition to MCS for 2 or more layers, instead of a single layer. Potential disadvantages of the third configuration include the UE supporting UE-RS based transmission and that virtual cell ID first introduced in LTE Rel-11.

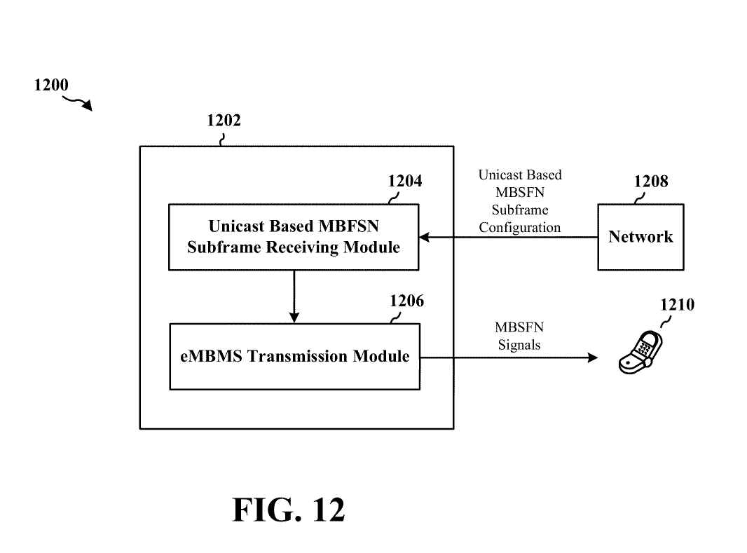

FIG. 12 is a conceptual data flow diagram 1200 illustrating the data flow between different modules/means/components in an exemplary apparatus 1202. The apparatus may be an eNB. The apparatus 1202 includes a unicast based MBSFN subframe receiving module 1204 and an eMBMS transmission module 1206. The unicast based MBSFN subframe receiving module 1204 receives a unicast based MBSFN subframe configured based on a unicast subframe structure. This unicast based MBSFN subframe configuration may be provided to the eNB by a network 1208. Receiving in this sense may encompass receiving information that defines the unicast based MBSFN configuration, such as the information described above. The eMBMS transmission module 1206 transmits MBSFN signals for eMBMS using the unicast based MBSFN subframe. The MBFSN signals may be received by a UE 1210.

The apparatus 1202 may include additional modules that perform each of the steps of the algorithm in the aforementioned flow chart of FIG. 11. As such, each step in the aforementioned flow chart of FIG. 11 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

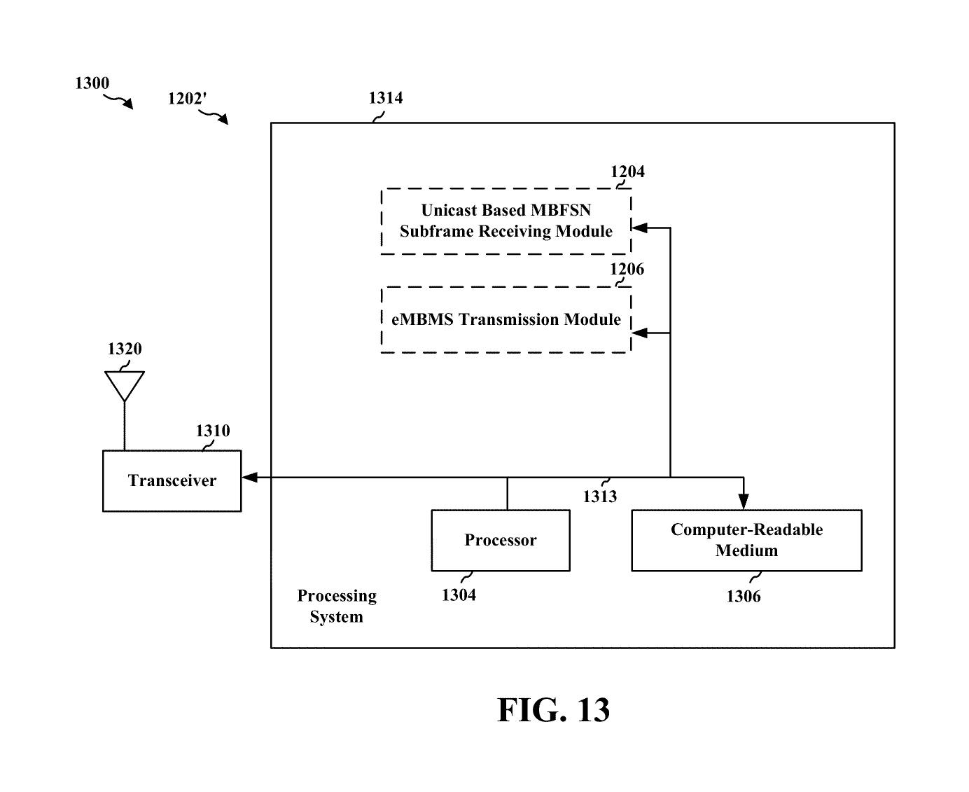

FIG. 13 is a diagram 1300 illustrating an example of a hardware implementation for an apparatus 1202′ employing a processing system 1314. The processing system 1314 may be implemented with a bus architecture, represented generally by the bus 1324. The bus 1324 may include any number of interconnecting buses and bridges depending on the specific application of the processing system 1314 and the overall design constraints. The bus 1324 links together various circuits including one or more processors and/or hardware modules, represented by the processor 1304, the modules 1204, 1206, and the computer-readable medium 1306. The bus 1324 may also link various other circuits such as timing sources, peripherals, voltage regulators, and power management circuits, which are well known in the art, and therefore, will not be described any further.

The processing system 1314 may be coupled to a transceiver 1310. The transceiver 1310 is coupled to one or more antennas 1320. The transceiver 1310 provides a means for communicating with various other apparatus over a transmission medium. The transceiver 1310 receives information from the processing system 1314, specifically the transmission module 1206, and based on the received information, generates a signal to be applied to the one or more antennas 1320. The processing system 1314 includes a processor 1304 coupled to a computer-readable medium 1306. The processor 1304 is responsible for general processing, including the execution of software stored on the computer-readable medium 1306. The software, when executed by the processor 1304, causes the processing system 1314 to perform the various functions described supra for any particular apparatus. The computer-readable medium 1306 may also be used for storing data that is manipulated by the processor 1304 when executing software. The processing system further includes at least one of the modules 1204, 1206. The modules may be software modules running in the processor 1304, resident/stored in the computer readable medium 1306, one or more hardware modules coupled to the processor 1304, or some combination thereof. The processing system 1314 may be a component of the eNB 610 and may include the memory 676 and/or at least one of the TX processor 616, the RX processor 670, and the controller/processor 675.

In one configuration, the apparatus 1202/1202′ for wireless communication includes means for receiving a unicast based MBSFN subframe configured based on a unicast subframe structure, and means for transmitting MBSFN signals for eMBMS using the unicast based MBSFN subframe. The aforementioned means may be one or more of the aforementioned modules of the apparatus 1202 and/or the processing system 1314 of the apparatus 1202′ configured to perform the functions recited by the aforementioned means. As described supra, the processing system 1314 may include the TX Processor 616, the RX Processor 670, and the controller/processor 675. As such, in one configuration, the aforementioned means may be the TX Processor 616, the RX Processor 670, and the controller/processor 675 configured to perform the functions recited by the aforementioned means.

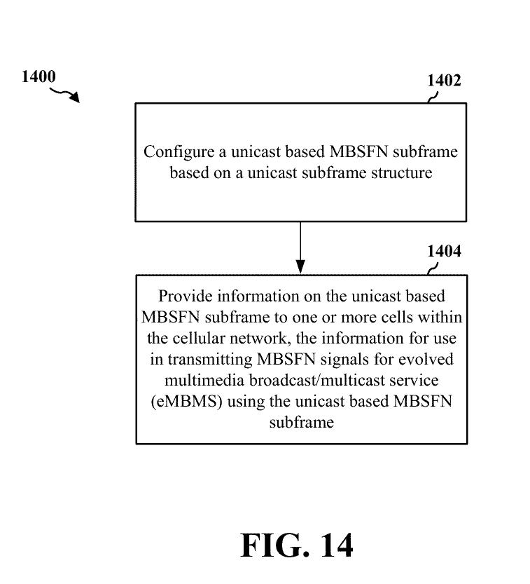

FIG. 14 is a flow chart 1400 of a method of wireless communication. The method may be performed by components of a cellular network. At step 1402, the one or more components of the cellular network configure a unicast based MBSFN subframe based on a unicast subframe structure. At step 1404, one or more components of the cellular network provide information on the unicast based MBSFN subframe to one or more cells within the cellular network. The information is for use in transmitting MBSFN signals for eMBMS using the unicast based MBSFN subframe.

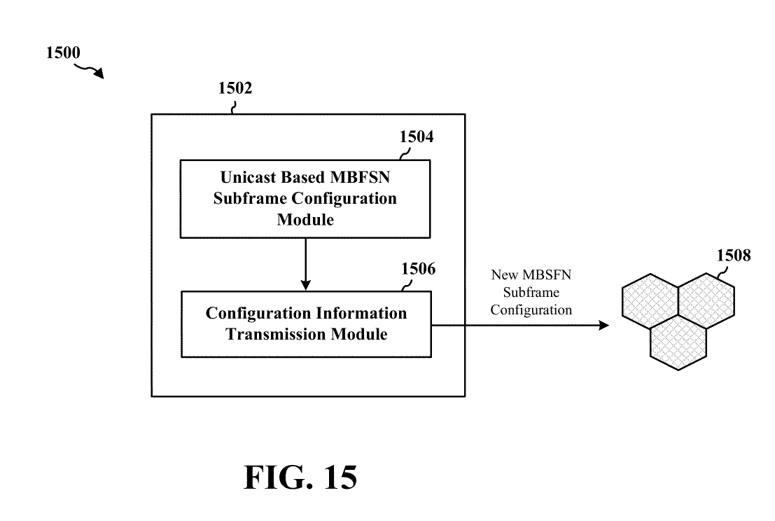

FIG. 15 is a conceptual data flow diagram 1500 illustrating the data flow between different modules/means/components in an exemplary apparatus 1502. The apparatus may be one or more components of a cellular network, such as a BM-SC or MCE or eNB. The apparatus includes a unicast based MBSFN subframe configuration module 1504 and a configuration information transmission module 1506. The unicast based MBSFN subframe configuration module 1504 configures a unicast based MBSFN subframe based on a unicast subframe structure. The configuration information transmission module 1506 provides information on the unicast based MBSFN subframe to one or more cells 1508 within the cellular network. The information is for use in transmitting MBSFN signals for eMBMS using the unicast based MBSFN subframe.

The apparatus may include additional modules that perform each of the steps of the algorithm in the aforementioned flow charts of FIG. 14. As such, each step in the aforementioned flow charts of FIG. 14 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

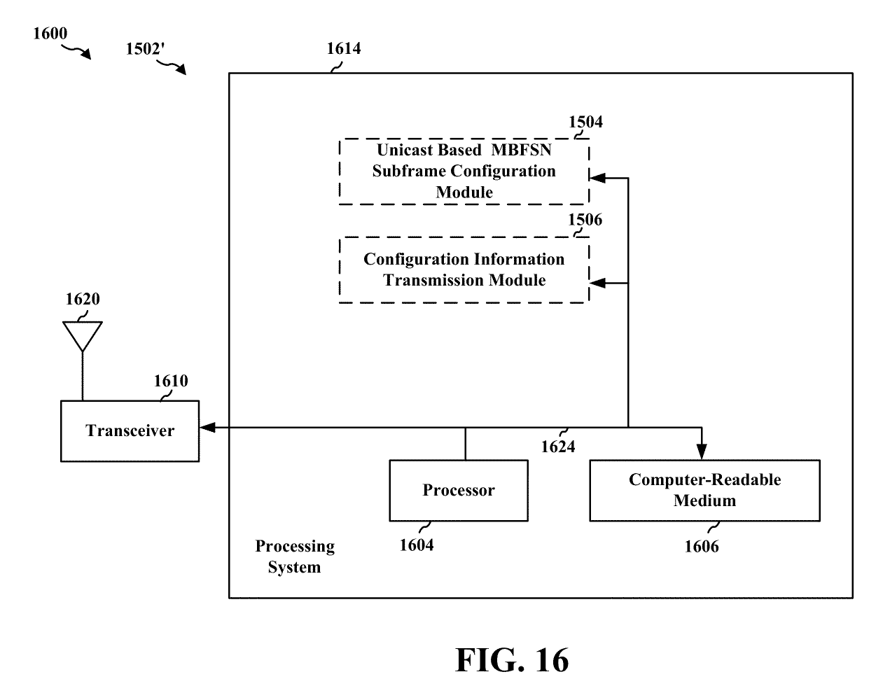

FIG. 16 is a diagram 1600 illustrating an example of a hardware implementation for an apparatus 1502′ employing a processing system 1614. The processing system 1614 may be implemented with a bus architecture, represented generally by the bus 1624. The bus 1624 may include any number of interconnecting buses and bridges depending on the specific application of the processing system 1614 and the overall design constraints. The bus 1624 links together various circuits including one or more processors and/or hardware modules, represented by the processor 1604, the modules 1504, 1506, and the computer-readable medium 1606. The bus 1624 may also link various other circuits such as timing sources, peripherals, voltage regulators, and power management circuits, which are well known in the art, and therefore, will not be described any further.

The processing system 1614 may be coupled to a transceiver 1610. The transceiver 1610 is coupled to one or more antennas 1620. The transceiver 1610 provides a means for communicating with various other apparatus over a transmission medium. The transceiver 1610 receives a signal from the one or more antennas 1620, extracts information from the received signal, and provides the extracted information to the processing system 1614. In addition, the transceiver 1610 receives information from the processing system 1614, and based on the received information, generates a signal to be applied to the one or more antennas 1620. The processing system 1614 includes a processor 1604 coupled to a computer-readable medium 1606. The processor 1604 is responsible for general processing, including the execution of software stored on the computer-readable medium 1606. The software, when executed by the processor 1604, causes the processing system 1614 to perform the various functions described supra for any particular apparatus. The computer-readable medium 1606 may also be used for storing data that is manipulated by the processor 1604 when executing software. The processing system further includes at least one of the modules 1504 and 1506. The modules may be software modules running in the processor 1604, resident/stored in the computer readable medium 1606, one or more hardware modules coupled to the processor 1604, or some combination thereof.

In one configuration, the apparatus 1502/1502′ for wireless communication includes means for configuring a unicast based MBSFN subframe based on a unicast subframe structure; and means for providing information on the unicast based MBSFN subframe to one or more cells within the cellular network, the information for use in transmitting MBSFN signals for evolved multimedia broadcast/multicast service (eMBMS) using the unicast based MBSFN subframe. The aforementioned means may be one or more of the aforementioned modules of the apparatus 1502 and/or the processing system 1614 of the apparatus 1502′ configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of wireless communication, comprising:
receiving a multicast/broadcast single frequency network (MBSFN) subframe configured based on a unicast subframe structure; and
transmitting MBSFN signals for evolved multimedia broadcast/multicast service (eMBMS) using the MBSFN subframe.

2. The method of claim 1, wherein the MBSFN subframe comprises a cyclic prefix (CP) length corresponding to a unicast CP length.

3. The method of claim 1, wherein the MBSFN subframe comprises a reference signal (RS) pattern corresponding to a unicast common RS (CRS) pattern.

4. The method of claim 1, wherein the MBSFN subframe comprises a reference signal (RS) pattern corresponding to a unicast UE specific RS (UE-RS) pattern.

5. The method of claim 4, wherein the RS is scrambled with an MBSFN area ID.

6. The method of claim 1, further comprising transmitting the MBSFN signals using one or more antennas corresponding to one or more antennas used for unicast transmissions.

7. The method of claim 6, wherein all cells in the MBSFN area have the same physical cell ID (PCI).

8. The method of claim 6, wherein the MBSFN signals are transmitted using a single antenna.

9. The method of claim 6, wherein the MBSFN signals are transmitted using a plurality of virtual antennas formed from a plurality of physical antennas.

10. The method of claim 1, wherein an allocation of the MBSFN subframe is declared in a system information block (SIB).

11. The method of claim 1, wherein at least one of an existing SIB13, multicast control channel (MCCH), physical downlink control channel (PDCCH) notification and MCCH scheduling information (MSI) is applied to the MBSFN subframe.

12. The method of claim 1, further comprising transmitting the MBSFN signals using a one or more antennas different from an antenna used for unicast transmissions.

13. The method of claim 12, wherein the MBSFN subframe comprises a RS pattern different from a unicast CRS pattern.

14. The method of claim 13, wherein the MBSFN subframe comprises a unicast RS pattern with a single antenna port in unicast and the unicast transmission uses a CRS pattern with more than one antenna port.

15. An apparatus for wireless communication, comprising:
means for receiving a multicast/broadcast single frequency network (MBSFN) subframe configured based on a unicast subframe structure; and
means for transmitting MBSFN signals for evolved multimedia broadcast/multicast service (eMBMS) using the MBSFN subframe.

16. The apparatus of claim 15, wherein the MBSFN subframe comprises a cyclic prefix (CP) length corresponding to a unicast CP length.

17. The apparatus of claim 15, wherein the MBSFN subframe comprises a reference signal (RS) pattern corresponding to a unicast common RS (CRS) pattern.

18. The apparatus of claim 17, wherein the MBSFN subframe comprises a reference signal (RS) pattern corresponding to a unicast UE specific RS (UE-RS) pattern.

19. The apparatus of claim 18, wherein the RS is scrambled with an MBSFN area ID.

20. The apparatus of claim 15, wherein the means for transmitting is configured to transmit the MBSFN signals using one or more antennas corresponding to one or more antennas used for unicast transmissions.

21. The apparatus of claim 20, wherein all cells in the MBSFN area have the same physical cell ID (PCI).

22. The apparatus of claim 20, wherein the MBSFN signals are transmitted using a single antenna.

23. The apparatus of claim 20, wherein the MBSFN signals are transmitted using two virtual antennas formed from four physical antennas.

24. The apparatus of claim 15, wherein an allocation of the MBSFN subframe is declared in a system information block (SIB).

25. The apparatus of claim 15, wherein at least one of an existing SIB 13, multicast control channel (MCCH), physical downlink control channel (PDCCH) notification and MCCH scheduling information (MSI) is applied to the MBSFN subframe.

26. The apparatus of claim 15, wherein the means for transmitting is configured to transmit the MBSFN signals using a one or more antennas different from an antenna used for unicast transmissions.

27. The apparatus of claim 26, wherein the MBSFN subframe comprises a RS pattern different from a unicast CRS pattern.

28. The apparatus of claim 27, wherein the MBSFN subframe comprises a unicast RS pattern with a single antenna port in unicast and the unicast transmission uses a CRS pattern with more than one antenna port.

29. A apparatus for wireless communication, comprising:
a processing system configured to:
receive a multicast/broadcast single frequency network (MBSFN) subframe configured based on a unicast subframe structure; and
transmit MBSFN signals for evolved multimedia broadcast/multicast service (eMBMS) using the MBSFN subframe.

30. A computer program product, comprising:
a computer-readable medium comprising code for:
receiving a multicast/broadcast single frequency network (MBSFN) subframe configured based on a unicast subframe structure; and
transmitting MBSFN signals for evolved multimedia broadcast/multicast service (eMBMS) using the MBSFN subframe.

31. A method of wireless communication in a cellular network, comprising:
configuring a multicast/broadcast single frequency network (MBSFN) subframe based on a unicast subframe structure; and
providing information on the MBSFN subframe to one or more cells within the cellular network, the information for use in transmitting MBSFN signals for evolved multimedia broadcast/multicast service (eMBMS) using the MBSFN subframe.

32. The method of claim 31, wherein the MBSFN subframe comprises a cyclic prefix (CP) length corresponding to a unicast CP length.

33. The method of claim 31, wherein the MBSFN subframe comprises a reference signal (RS) pattern corresponding to a unicast common RS (CRS) pattern.

34. The method of claim 31, wherein the MBSFN subframe comprises a reference signal (RS) pattern corresponding to a unicast UE specific RS (UE-RS) pattern.

35. The method of claim 34, wherein the RS is scrambled with an MBSFN area ID.

36. The method of claim 31, wherein an allocation of the MBSFN subframe is declared in a system information block (SIB).

37. The method of claim 31, wherein at least one of an existing SIB13, multicast control channel (MCCH), physical downlink control channel (PDCCH) notification and MCCH scheduling information (MSI) is applied to the MBSFN subframe.

38. A wireless communications network, comprising:
means for configuring a multicast/broadcast single frequency network (MBSFN) subframe based on a unicast subframe structure; and
means for providing information on the MBSFN subframe to one or more cells within the cellular network, the information for use in transmitting MBSFN signals for evolved multimedia broadcast/multicast service (eMBMS) using the MBSFN subframe.

39. The network of claim 38, wherein the MBSFN subframe comprises a cyclic prefix (CP) length corresponding to a unicast CP length.

40. The network of claim 38, wherein the MBSFN subframe comprises a reference signal (RS) pattern corresponding to a unicast common RS (CRS) pattern.

41. The network of claim 38, wherein the MBSFN subframe comprises a reference signal (RS) pattern corresponding to a unicast UE specific RS (UE-RS) pattern.

42. The network of claim 41, wherein the RS is scrambled with an MBSFN area ID.

43. The network of claim 38, wherein an allocation of the MBSFN subframe is declared in a system information block (SIB).

44. The network of claim 38, wherein at least one of an existing SIB13, multicast control channel (MCCH), physical downlink control channel (PDCCH) notification and MCCH scheduling information (MSI) is applied to the MBSFN subframe.

45. A wireless communications network, comprising:
a processing system configured to:
configure a multicast/broadcast single frequency network (MBSFN) subframe based on a unicast subframe structure; and
provide information on the MBSFN subframe to one or more cells within the cellular network, the information for use in transmitting MBSFN signals for evolved multimedia broadcast/multicast service (eMBMS) using the MBSFN subframe.

46. A computer program product, comprising:
a computer-readable medium comprising code for:
configuring a multicast/broadcast single frequency network (MBSFN) subframe based on a unicast subframe structure; and
providing information on the MBSFN subframe to one or more cells within the cellular network, the information for use in transmitting MBSFN signals for evolved multimedia broadcast/multicast service (eMBMS) using the MBSFN subframe.

47. A method of wireless communication by a user equipment, comprising:
receiving configuration information for a multicast/broadcast single frequency network (MBSFN) subframe configured based on a unicast subframe structure; and
obtaining MBSFN signals for evolved multimedia broadcast/multicast service (eMBMS) transmitted in the MBSFN subframe.

48. The method of claim 47, wherein the configuration information is received in a system information block (SIB).

49. The method of claim 47, wherein the MBSFN subframe configuration uses a same RS pattern as that used in a unicast subframe, and further comprising:
performing channel estimations over a series of subframes regardless of whether individual subframes in the series are allocated as a unicast subframe or a MBSFN subframe configured based on a unicast subframe structure.

50. An apparatus for wireless communication, comprising:
means for receiving configuration information for a multicast/broadcast single frequency network (MBSFN) subframe configured based on a unicast subframe structure; and
means for obtaining MBSFN signals for evolved multimedia broadcast/multicast service (eMBMS) transmitted in the MBSFN subframe.

51. The apparatus of claim 50, wherein the configuration information is received in a system information block (SIB).

52. The apparatus of claim 50, wherein the MBSFN subframe configuration uses a same RS pattern as that used in a unicast subframe, and further means for comprising performing channel estimations over a series of subframes regardless of whether individual subframes in the series are allocated as a unicast subframe or a MBSFN subframe configured based on a unicast subframe structure.

53. An apparatus for wireless communication, comprising:
a processing system configured to:
receive configuration information for a multicast/broadcast single frequency network (MBSFN) subframe configured based on a unicast subframe structure; and
obtain MBSFN signals for evolved multimedia broadcast/multicast service (eMBMS) transmitted in the MBSFN subframe.

54. A computer program product, comprising:
a computer-readable medium comprising code for:
receiving configuration information for a multicast/broadcast single frequency network (MBSFN) subframe configured based on a unicast subframe structure; and
obtaining MBSFN signals for evolved multimedia broadcast/multicast service (eMBMS) transmitted in the MBSFN subframe.
